(19) United States
(12) Patent Application Publication
(10) Pub. No.: US 2012/0164377 A1
(43) Pub. Date: Jun. 28, 2012

(54) SPORTS PAD

(76) Inventor: Tsang-Po LIN, Taya Township (TW)

(21) Appl. No.: 12/980,045

(22) Filed: Dec. 28, 2010

(51) Int. Cl. B32B 3/10

(52) U.S. Cl. 428/137

(57) ABSTRACT

A sports pad is a pad-shaped main unit assembled primarily by an outer layer, an adhesive layer and an inner layer. Ventilation holes are formed in the pad-shaped main unit by punching at one time with a mold tool to penetrate the outer layer, the adhesive layer and the inner layer. A hot-press formation and a cutting are carried out next to accomplish the sports pad having a pre-determined shape, having a concaved and convex arc at a pre-determined position and manifesting a fused and smooth pattern at outer peripheries. The outer side of the pad is a high-intensity structure to provide stopping and protection functions; whereas, the inner side is a soft and fitting material, providing comfortableness when wearing.

### BACKGROUND OF THE INVENTION

a) Field of the Invention

The present invention relates to a sports aiding tool and more particularly to a sports pad which is provided with a unique structure, is used comfortably, as well as provides better ventilation and protection functions.

b) Description of the Prior Art

It is known that a user should put on or wear so-called protective equipment or a protective pad at a specific part of body, such as an elbow, a knee, two sides of a waist or a front chest, to protect that part or buffer an impact force acting upon that part, when doing some specific sports. The most commonly seen are a knee pad on a foot and an elbow pad on an arm of a skier when skiing or playing hockey, as well as a knee pad, an elbow pad and protective equipment on a front chest of a baseball player. Referring to FIG. 1, the conventional protective equipment or protective pad is a single foam board 1 made of PE (polyethylene) or EVA (ethylene vinyl acetate), on which is first formed with plural holes 2. As shown in FIG. 2, the foam board 1 is cut into a pad-shaped main unit 3 in a pre-determined shape. As shown in FIG. 3, peripheries of the pad-shaped main unit 3 should be performed with edge wrapping by a side strap 4 made of fabric or rubber. As the conventional protective equipment or protective pad is made of a single material, if the material itself is softer, then the provided buffering and protecting effects will not be so perfect. However, when putting on a body to contact with the human body, the user will feel more comfortable as the protective equipment of protective pad is softer. On the contrary, when the protective equipment or protective pad made of a harder material is used, a larger impact force can be stopped to provide a better protection effect; yet, it will be less conforming when putting on the body to contact with the human body and the user will not feel so comfortable. Moreover, it can even result in a shortcoming that a skin may be excoriated and wounded as the protective equipment or protective pad frictions with the body. Accordingly, it is a goal to be pursued by a researcher and is also preferred by all sports lovers to provide a pad which is provided with better buffering and protection effects, as well as is softer and more conforming without injuring the skin while being in contact with the body.

### SUMMARY OF THE INVENTION

The primary object of the present invention is to provide a sports pad which is made of a same material of different densities to form a structure that is soft inside and hard outside. The sports pad of the present invention provides better buffering and protecting effects, as well as is soft and conforming while in use, without injuring the skin.

Accordingly, the present invention provides a sports pad which includes primarily an outer layer which is at a top layer and is made of a high-density elastic material to provide better buffering and stopping functions; an inner layer which is at a bottom layer and is made of a low-density elastic material to provide proper softness that it is more conforming and comfortable when contacting with the human body; and an adhesive layer which is provided between the outer layer and the inner layer to adhere and assemble the outer layer with the inner layer, thereby assembling into a pad-shaped main unit. This pad-shaped main unit is then punched at one time through a mold tool to penetrate the outer layer, the adhesive layer and the inner layer, forming plural ventilation holes. Next, the main unit is formed by hot pressing and is cut to accomplish a sports pad having a pre-determined shape or having a concaved and convex arc at a pre-determined position. An exterior side of the sports pad is a high-intensity structure to provide stopping and protecting functions, whereas an inner side is a soft and conforming structure to provide an effect that the sports pad is comfortable when wearing to use.

The outer layer is manufactured by a high-density EVA material and the inner layer is manufactured by a low-density EVA material.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional schematic view of a conventional foam board.

FIG. 2 shows a schematic view of a pad-shaped main unit which is cut into a pre-determined shape of FIG. 1.

FIG. 3 shows a top view of edge wrapping of the pad-shaped main unit of FIG. 2.

FIG. 4 shows a three-dimensional exploded view of a pad-shaped main unit, according to a preferred embodiment of the present invention.

FIG. 5 shows a schematic view of a manufacturing process of the preferred embodiment of the present invention.

FIG. 6 shows a three-dimensional schematic view of the preferred embodiment of the present invention.

FIG. 7 shows a cutaway view along a line B-B in FIG. 6, according to the preferred embodiment of the present invention.

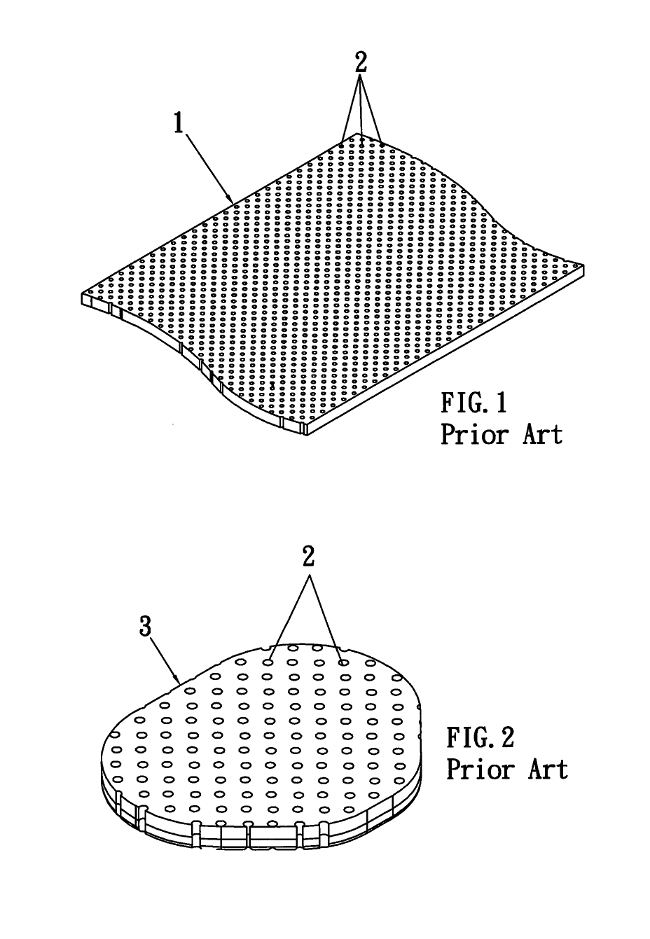

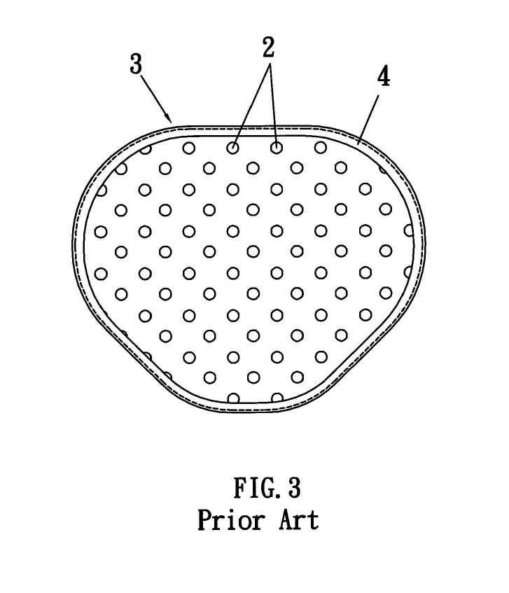

### DETAILED DESCRIPTION OF THE PREFERRED EMBODIMENTS

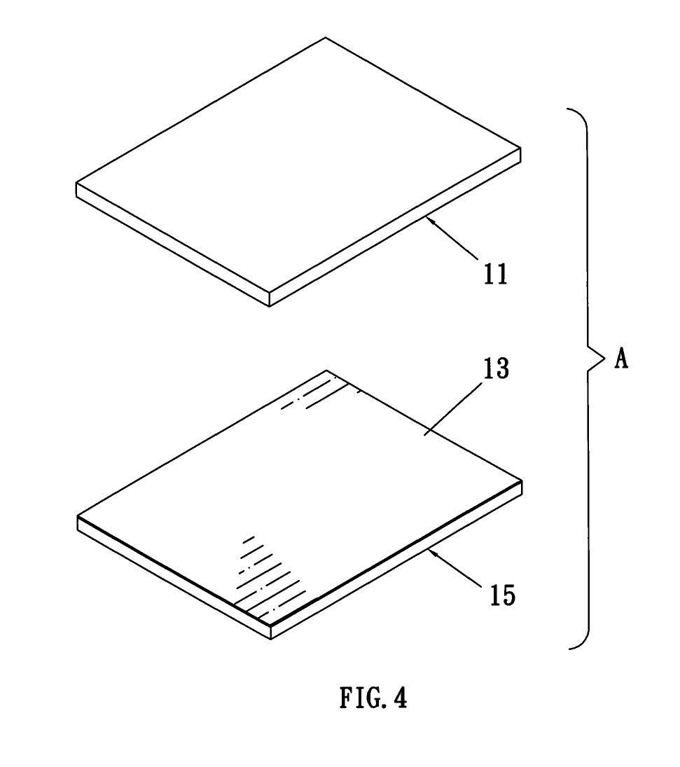

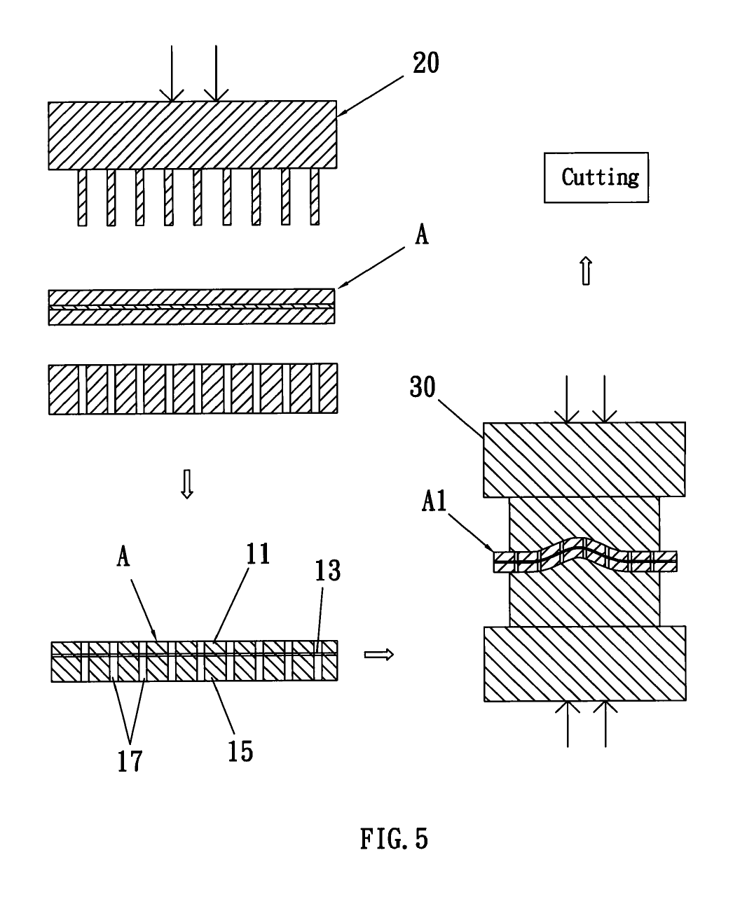

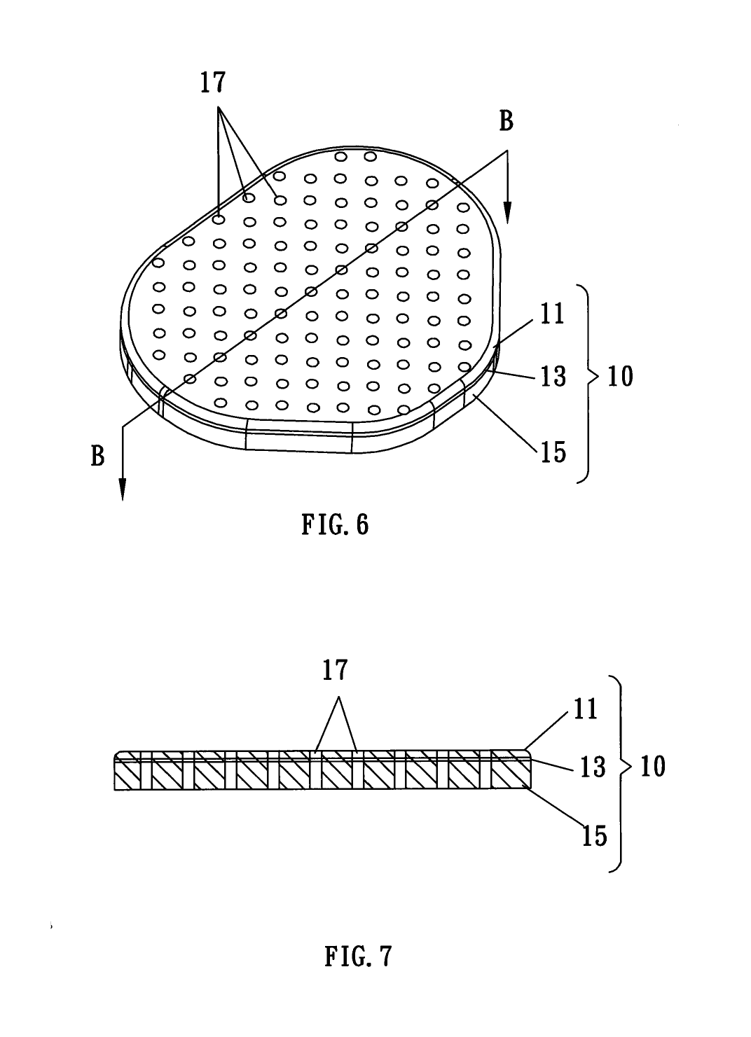

Referring to FIG. 4, a sports pad, according to a preferred embodiment of the present invention, comprises primarily a pad-shaped main unit A which is assembled orderly by an outer layer 11, an adhesive layer 13 and an inner layer 15. As shown in FIG. 5, plural ventilation holes 17 are formed by punching at one time through a hole-punching mold 20 to penetrate the outer layer 11, the adhesive layer 13 and the inner layer 15. Next, a hot pressing is performed with a hot-press mold 30, allowing the pad-shaped main unit A to become a flat plate or a pad A1 having a concaved and convex arc. Finally, a cutting is carried out to accomplish a sports pad 10 of the present invention, which is a plate-shaped sports pad 10 as shown in FIG. 6. A normal knee pad is roughly in a circular shape or a triangular shape as shown in FIG. 6; whereas, a normal elbow pad is roughly a long rectangle and a chest pad is a trapezoid of a larger area. Of course, these pads should fit with an elastic fabric sheath or a back belt, a fastening belt with snaps to accomplish complete protective equipment (they are all not shown in the drawings and as they belong to a prior art, no further description is provided).

Referring to FIG. 6 and FIG. 7, for the sports pad 10 that is manufactured by the abovementioned process, the outer layer 11, which is at a top layer or an outer side of the accomplished sports protective equipment, is made of a high-density EVA material, with a higher hardness to provide better buffering and stopping functions, thereby preventing the user from getting an impact in sports and protecting the user's body from getting injured. The inner layer 15, which is at a bottom layer or an inner side of the accomplished sports protective equipment, i.e., an inner surface to contact with the user's body when the user wears on the sports protective equipment, is made of a low-density EVA material, with a lower density to provide proper softness, thereby being more conforming and comfortable when contacting with the human body, without being too hard and the shape being unable to conform to the body like the prior art that the skin can be bruised as the conventional protective equipment frictions with the body easily. The inner layer 15 of the present invention can totally remove the shortcomings of the prior art to achieve the expected double effects that the sports pad is used more conformingly and comfortably, as well as is provided with the better buffering and protecting functions.

Furthermore, for the sports pad 10 of the present invention, the pad-shaped main unit A is primarily formed through hot pressing and cut, enabling the pad-shaped main unit A to become the pad A1 in a plate shape or having the concaved and convex arc. As outer peripheries of the entire pad A1 are integrated by fusing and manifest a smooth pattern, there is no need to carry out edge wrapping with the fabric or rubber side trap as the prior art. Therefore, a material cost of the side strap can be saved and a manufacturing cost of processing can be reduced, which can even promote industrial upgrading.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A sports pad comprising:
an outer layer, which is at a top layer and is made of a high-density EVA (ethylene vinyl acetate) material to provide better buffering and stopping functions;
an inner layer, which is at a bottom layer and is made of a low-density EVA material to provide proper softness that when being in contact with a human body, the sports pad is more conforming and comfortable; and
an adhesive layer, which is provided between the outer layer and the inner layer to adhere and assemble the outer layer with the inner layer, thereby assembling into a pad-shaped main unit; the pad-shaped main unit being formed with plural ventilation holes by one punching with a mold tool to penetrate the outer layer, the inner layer and the adhesive layer, the pad-shaped main unit then being formed by hot pressing and being cut to accomplish a pad having a pre-determined shape; outer peripheries of the pad being fused to manifest a smooth pattern, an outer side of the pad being a high-intensity structure to provide the buffering and protecting functions and an inner side of the pad being a soft and conforming structure to provide protection and an effect that the pad is comfortable when wearing to use.

2. The sports pad according to claim 1, wherein the pad-shaped mail unit is formed with a concaved and convex are at a pre-determined position.
